(19) United States
(12) Patent Application Publication
(10) Pub. No.: US 2023/0204514 A1
(43) Pub. Date: Jun. 29, 2023

(54) METHOD AND DEVICE FOR DETERMINING POSITIONS OF MOLECULES IN A SAMPLE

(71) Applicant: ABBERIOR INSTRUMENTS GMBH, Gottingen (DE)

(72) Inventors: Gerald DONNERT, Gottingen (DE); Lars KASTRUP, Gottingen (DE); Roman SCHMIDT, Gottingen (DE); Winfried WILLEMER, Bovenden (DE); Andreas SCHONLE, Gottingen (DE)

(21) Appl. No.: 17/926,862

(22) PCT Filed: May 25, 2021
(86) PCT No.: PCT/EP2021/063784

§ 371 Date: Nov. 21, 2022

(30) Foreign Application Priority Data
May 26, 2020 (DE) 10 2020 113 998.5
Jun. 23, 2020 (DE) 10 2020 116 547.1
May 14, 2021 (EP) 21173820.8

(51) Int. Cl. G01N 21/64; G02B 21/00

(52) U.S. Cl. CPC G01N 21/6458; G02B 21/0032; G02B 21/0076; G01N 2021/174

(57) ABSTRACT

The invention relates to a method for determining positions of mutually spaced molecules (M) in a sample (20), having the steps of generating (101) a plurality of light distributions, each light distribution having a local intensity minimum (110, 310) and adjacent regions (120, 320) of increasing intensity, comprising an excitation light distribution (100) and a deactivation light distribution (300); illuminating (102) the sample (20) with the excitation light distribution (100) and the deactivation light distribution (300); detecting (103) photons emitted by the molecule (M) for different positions of the excitation light distribution (100); and deriving (104) the position of the molecule (M) on the basis of the photons detected for the different positions of the excitation light distribution (100), wherein the local minimum (110) of the excitation light distribution (100) is arranged at a plurality of scanning positions (201) one after the other within a scanning region (200), and the light intensity of the deactivation light in a catching region (210), which is paired with the scanning region (200) and in which the position of the molecule (M) can be unambiguously derived from the scanning positions (201) and the paired detected photons, corresponds maximally to three times the saturation intensity of the deactivation light. The invention further relates to a device for carrying out said method.

### TECHNICAL FIELD OF THE INVENTION

The invention relates to a method and a device for determining positions of spaced apart molecules in one or more spatial directions in a sample, in particular according to a MINFLUX method.

### PRIOR ART

Single molecule localization and tracking methods based on the MINFLUX method according to the prior art are described, e.g., in patent applications DE 10 2011 055 367 A1. WO 2015/052186 A1, patent specification DE 10 2013 114 860 and the publication Balzarotti F, Eilers Y, Gwosch K C, Gynnå, A, Westphal V, Stefani F, Elf J, Hell S W “Nanometer resolution imaging and tracking of fluorescent molecules with minimal photon fluxes”, arXiv:1611.03401 [physics.optics] (2016).

Essentially, therein, a sample with fluorophores is scanned with an excitation intensity distribution that has a local intensity minimum in the center surrounded by intensity maxima. Such intensity distributions are known, for example, from STED (Stimulated Emission Depletion) microscopy.

In MINFLUX microscopy, on the other hand, the sample is scanned step by step with the minimum of the excitation light distribution. First, a single fluorophore is located with an independent method and in a pre-localization step the position of the fluorophore is roughly estimated. Then, the central minimum of the excitation light distribution is positioned successively at more than one position near the estimated position, and an emission signal is measured for each position, preferably by counting single fluorescence photons with a confocal point detector. The measured fluorescence intensity or the counted number of photons per time unit depends for each position of the excitation light distribution on the distance between the minimum of the excitation light distribution and the actual location of the fluorophore: the closer to the minimum the fluorophore is located, the lower the fluorescence signal. In this way, the position of a single fluorophore can be determined, especially iteratively, with extremely high accuracy (up to 1 nm). For this purpose, modified maximum likelihood estimators, e.g., are used according to the prior art.

Another advantage of MINFLUX microscopy, besides its very high accuracy, is its high photon efficiency: on average, a significantly smaller number of excitation photons are needed to localize a fluorophore than, e.g., in single-molecule localization using PALM/STORM microscopy, which reduces bleaching and phototoxicity (in the case of living samples). This results from the fact that usually with each iteration the minimum of the excitation light distribution gets closer and closer to the actual fluorophore position—with each step the fluorophore is exposed to fewer photons.

STED microscopy is based on the depletion of fluorescence through stimulated emission: by irradiating STED light of a suitable wavelength, fluorophores can be selectively (re)moved from the excited state to the ground state, in which the fluorophores no longer fluoresce.

In STED microscopy, an approximately Gaussian excitation light distribution is usually superimposed with a, e.g., donut-shaped, STED light distribution with a local minimum, whereby the maximum of the excitation light distribution is brought to coincide with the minimum of the STED light distribution. As a result, fluorophores located outside the center are specifically excited by the STED light and thus do not contribute to the fluorescence signal. In this way, the effective resolution can be reduced far below the diffraction limit.

In some prior art documents, a combination of MINFLUX methods and similar single molecule localization methods with STED microscopy has already been proposed.

For example, patent applications DE 10 2017 104 736 A1 and EP 3 372 989 A1 describe a superposition of an excitation light distribution with a local maximum with a STED light distribution with a local minimum. The sample is scanned by shifting the STED distribution with the STED minimum and the position of the fluorophore is determined by a fit algorithm from the measured values of the fluorescence intensity at different positions of the STED intensity distribution. The STED light can be used to suppress additional fluorescence light caused by other fluorophores located in the vicinity of the fluorophore to be localized. However, the method described is significantly less photon-efficient, especially compared to the conventional MINFLUX method, because the effective emission (detection) point spread function (PSF) resulting from the superimposed light distributions has a maximum in the center instead of a minimum (as MINFLUX microscopy).

Furthermore, a method is known from WO 2020/198750 A1 in which a sample is labelled with a first and a second fluorophore, the excitation and emission wavelengths of the two fluorophores being different. In a 4π microscope arrangement (i.e., an arrangement in which the light beams are focused on the sample by two objectives positioned on opposite sides of the sample in the axial direction, these light beams at least partially interfering with each other), the position of the first fluorophore is determined, e.g. by MINFLUX nanoscopy at short intervals, and the position of the sample relative to the beam path of the microscope is readjusted on the basis of the determined position in such a way that the first fluorophore is always in the center of the field of view during the experiment. To localize or image the second fluorophore relative to the first fluorophore, the second fluorophore is then exposed to a Gaussian-shaped excitation light distribution in the range of the excitation wavelength of the second fluorophore, which is superimposed with a donut-shaped STED light distribution that affects only the fluorescence of the second fluorophore. This method can be used, for example, to localize and track RNA polymerase complexes labeled with the second fluorophore relative to specific gene loci labeled with the first fluorophore in biological cells.

Furthermore, patent specification EP 3 055 674 B1 and patent application US 2014/0042340 A1 disclose a MINFLUX-based single molecule tracking method in which an excitation light distribution with a local minimum and a STED distribution with a local minimum are concentrically superimposed. The width and shape of the minimum of the STED distribution essentially corresponds to the width and shape of the excitation distribution, except for a small wavelength-dependent deviation. Due to the additional STED light, the fluorophores are only excited by the excitation light in a narrow area around the center. This means that it is not necessary to separate a fluorophore in the area of the entire field of view, but separation only has to be achieved for the narrower area of the STED minimum in order to follow the movement of a fluorophore.

An analogous combination of MINFLUX and STED techniques is also disclosed in Chinese patent application CN 111024658 A, according to which a sample is jointly scanned with concentrically arranged excitation and STED light distributions to locate individual fluorophores in the sample.

With the help of the described methods, additional STED light can be used, in particular, to reduce disturbing background fluorescence during MINFLUX localization of individual fluorophores.

However, these have the disadvantage that the effective PSF of the fluorescence emission light (detection light) is influenced by both the excitation light distribution and the STED light distribution. This results, in particular, in a reduced gradient of the effective excitation and a reduced detection efficiency. Furthermore, the methods require a relatively good knowledge of the position of the molecule to be localized.

### OBJECTIVE OF THE INVENTION

The invention is therefore based on the objective of providing a method and a device for determining, in one or more spatial directions, positions of molecules spaced apart from one another in a sample, which reduces the background fluorescence in MINFLUX localization in an improved manner with respect to the disadvantages of the prior art explained above.

### SOLUTION

The objective of the invention is attained by a method with the features of independent claim 1 and a device with the features of claim 13. The dependent claims 2 to 12 relate to advantageous embodiments of the method and the dependent claims 14 and 15 relate to advantageous embodiments of the device.

### DESCRIPTION OF THE INVENTION

The method according to a first aspect of the invention serves to determine positions of molecules spaced apart from one another in one or more spatial directions in a sample.

In particular, the spaced-apart molecules are adapted to emit emission light of a second wavelength when the sample is illuminated with excitation light of a first wavelength, wherein the emission light may be, for example, fluorescent light.

The light-emitting molecules are spaced apart from one another, i.e. singled out. In other words, the molecules have such a mean distance from one another that they can be localized separately from one another using the method according to the invention. Since the method according to the invention is, in particular, a non-diffraction-limited localization method, the mean distance can thereby be, in particular, below the wavelength of the excitation light and/or the deactivation light. In some applications, however, it may still be advantageous if the mean distance is at least equal to the wavelength of the excitation light and/or the deactivation light. In this case, it is particularly possible to pre-localize the individual molecules using diffraction-limited methods such as PALM/STORM microscopy with lower resolution camera imaging.

The spacing apart of the molecules can be achieved in the case of fluorophores (also referred to as, fluorescent dye’ in the context of this application), e.g., by labeling molecules of the sample with a defined amount of fluorophores, resulting in a desired labeling density of the sample. Alternatively, however, it is also possible, e.g., to label the sample with a higher density of fluorophores if not all fluorophores emit light simultaneously. For this purpose, for example, the blinking behavior of the fluorophores can be exploited, i.e., the property of spontaneously changing with a certain probability from an active state, in which fluorescent light is emitted when excitation light is irradiated, to an inactive state, in which no fluorescent light is emitted when excitation light is irradiated. Of course, a subset of the fluorophores can also be selectively converted to the active or inactive state, e.g., by irradiating activation light (also referred to as switching light) or deactivation light of suitable wavelength (especially when using so-called switchable fluorophores) to separate the active fluorophores.

Determining positions of molecules is also referred to herein as localization or localization, and in particular includes determining positions with an accuracy in the range of 1 nm to 100 nm, further in particular 1 nm to 10 nm.

The position can be determined in one spatial direction, in two spatial directions or in three spatial directions. In particular, the two spatial directions run perpendicular to an optical axis along which the excitation light and, in particular, the deactivation light is irradiated onto the sample, i.e. the two directions form a plane (x-y plane) perpendicular to the optical axis, in particular a focal plane in the sample. In the case of position determination in three spatial directions, the third spatial direction is in particular parallel to the optical axis (i.e., in the z-direction). However, other spatial directions are of course also possible, e.g., planes arranged obliquely to the optical axis.

The method comprises the following steps:

generating a plurality of light distributions, each light distribution comprising a local intensity minimum and intensity increasing regions adjacent thereto, the light distributions comprising an excitation light distribution and a deactivation light distribution,

illuminating the sample with the excitation light distribution and the deactivation light distribution,

detecting photons emitted by the molecule for different positionings of the excitation light distribution, and

deriving the position of the molecule based on the photons detected for the different positionings of the excitation light distribution.

The light distributions (i.e., spatial intensity distributions of light) each have a local intensity minimum, i.e., one point or several adjacent points in space, at which a minimum light intensity prevails. The minimum light intensity may be zero or near zero, i.e., no greater than a background light intensity. In particular, the local intensity minima of the excitation light distribution and the deactivation light distribution lie in a focal plane in the sample. In particular, the excitation light distribution and/or the deactivation light distribution are symmetrically formed, with the respective local intensity minimum being located in a center of the respective light distribution. Of course, the excitation light distribution and/or the deactivation light distribution can also each have several local minima, e.g., in the case of periodic light distributions such as line patterns or two-dimensional or three-dimensional gratings.

The light distributions are generated in particular by generating a light beam of coherent light (i.e., an excitation light beam and a deactivation light beam) for each light distribution, e.g., from a laser source, and wherein the light beams are each amplitude or phase modulated and focused into the sample, in particular with an objective. Due to the amplitude or phase modulation, the light distributions described above with the local minima then result in the focus. The light beams can be amplitude or phase modulated separately or together. For example, a so-called 2D donut or 3D donut can respectively be generated by phase modulation.

The term ‘excitation light’ in the context of the present specification means light having a suitable wavelength to excite the spaced apart molecules, especially the fluorophores, in the sample so that they emit photons, especially fluorescence.

By ‘deactivation light’ in the context of the present specification is meant light that prevents the spaced-apart molecules from emitting photons upon irradiation of the excitation light. For this purpose, the deactivation light may, for example, convert the molecules from an excited state to a ground state or a vibrational state above the ground state, e.g., by stimulated emission. Alternatively, it is also possible that the deactivation light transfers the molecules in an inactive state, e.g., a dark state, in which they cannot emit photons. Furthermore, the deactivation light according to the present invention could also prevent the molecules from changing from an inactive state to an active state. In the context of the present specification, the deactivation light may also be referred to as fluorescence prevention light, and in particular is stimulation light or STED light.

According to the method of the invention, the excitation light distribution and the deactivation light distribution illuminate the sample, i.e., the excitation light distribution illuminates at least a part of the sample in which the molecule to be localized is located.

The emitted photons are detected in particular with a point detector such as a single photon avalanche diode (SPAD), a photomultiplier tube (PMT) or a hybrid detector or an area detector comprising several point detectors arranged in an image plane, e.g., of the types mentioned above. Thereby, for example, a count rate, i.e., a number of detected photons per unit time, can be determined, which can be treated analogously to an emission intensity for a single molecule.

To reposition the excitation light distribution, e.g., the excitation light beam can be shifted relative to the sample, e.g., with one or more electro optical deflector(s) (EOD), acousto optical deflector(s) (AOD), galvanometric scanners, micromirror arrays or spatial light modulators (SLM). As an alternative to beam deflection, a sample holder to which the sample is attached can of course also be repositioned relative to the excitation light beam, for example with piezoelectric elements.

The emitted photons are detected for each positioning of the excitation light distribution and the position of the molecule is determined from the positionings of the excitation light distribution and the respective assigned emission light intensities or photon count rates. This can be done, e.g., according to a MINFLUX method. This method takes advantage of the fact that the closer the molecule is to the local minimum of the excitation light distribution, the fewer photons are emitted by the molecule. The position of the molecule can be estimated, for example, by means of a, possibly modified, maximum likelihood estimator, in particular as known from the prior art.

The method according to the invention is characterized, in particular, in that the local minimum of the excitation light distribution is successively arranged at a plurality of scanning positions within a scanning region, wherein the light intensity of the deactivation light in a catch region assigned to the scanning region, in which the position of the molecule can be unambiguously derived from the scanning positions and the associated detected photons, corresponds at most to three times a saturation intensity, particularly at most twice the saturation intensity, more particularly at most the saturation intensity. In particular, the light intensity of the deactivation light corresponds at most to three times the saturation intensity of the deactivation light, particularly at most twice the saturation intensity, further particularly at most the saturation intensity, also in the scanning region.

Therein, the term ‘saturation intensity’ refers to the light intensity of the deactivation light at which 50% of the molecules, particularly fluorophores, are deactivated (e.g., in the case of STED light by stimulated emission).

If the molecule is located in the catch region, the molecule can be unambiguously localized by evaluating the photon numbers for the respective scanning positions. Outside the catch region, on the other hand, several estimated positions of the molecule can particularly result from the determined photon numbers. This means, for example, that a maximum likelihood estimator determined on the basis of the photon numbers and scanning positions provides unambiguous values, provided that the molecule is actually located in the catch region. The catch region is in particular smaller than the scanning region but can also be equal to or larger than the scanning region, depending on the pattern (set of targeted coordinates, STC) of the scanning positions and in particular the position estimator used. Furthermore, the catch region can form a surface (e.g., in the focal plane for 2D localization) or a volume (for 3D localization).

A maximum intensity of the deactivation light in the catch region, which corresponds to at most three times the saturation intensity, can be achieved, e.g., by a wider deactivation light distribution (e.g., by an adjustment of the intensity or the phase modulation) compared to the excitation light distribution. Therein, the excitation light distribution can be repositioned, e.g., within a wider range around the minimum of a stationary deactivation light distribution, or the deactivation light distribution may be repositioned together with the excitation light distribution.

In particular, the method according to the invention can achieve that an effective detection point spread function (PSF), in particular a width of the effective detection point spread function (e.g., defined as full width at half maximum, FWHM) is largely unaffected by the deactivation light distribution, regardless of where within the catch region the molecule is actually located.

Therein, the term ‘effective detection PSF’ refers to the distribution of the emission light emitted by the molecule after excitation with the excitation light, which results from diffraction by the optical system. In principle, the detection PSF results here from a combination of the excitation PSF and the PSF of the deactivation light. However, in the method according to the invention, it is possibly distorted due to the fact that the excitation PSF and the deactivation PSF are not arranged concentrically to each other and thus there is a deviation from the position of the center of a projection of the detection pinhole aperture, i.e., a non-confocal arrangement.

In prior art STED microscopy (where the STED light corresponds to the deactivation light), the effective detection PSF is purposefully narrowed by the STED light to increase the resolution to below the diffraction limit.

In contrast, the light distributions according to the present invention are designed such that the effective detection PSF is essentially influenced only by the excitation light distribution. Thus, in particular, the detection PSF is not intended to be narrowed in the method according to the present invention. Rather, the deactivation light is intended to suppress background emission from additional fluorophores located in the region of the excitation light distribution or in the vicinity th ereof in order to increase the signal-to-background ratio. The fact that the deactivation light distribution has only a small effect on the effective PSF of the photon emission has the advantage here that the suppression of background fluorescence is possible with simultaneous simpler and more accurate position determination of the molecule.

According to one embodiment, the light intensity of the deactivation light at the scanning positions is at most 50% of the saturation intensity, in particular at most 45% of the saturation intensity, further in particular at most 40% of the saturation intensity, further in particular at most 35% of the saturation intensity, further in particular at most 30% of the saturation intensity, further in particular at most 25% of the saturation intensity, further in particular at most 20% of the saturation intensity, further in particular at most 15% of the saturation intensity, further in particular at most 10% of the saturation intensity, further in particular at most 5% of the saturation intensity.

According to one embodiment, the deactivation light is STED light, i.e., light that transfers the molecules, in particular fluorophores, in a vibrational state above the ground state by stimulated emission, from which they transition to the ground state without emitting a photon.

According to a further embodiment, the excitation light distribution is repositioned while the deactivation light distribution is left stationary so that the local minimum of the excitation light distribution is positioned differently more than once within a vicinity of the local intensity minimum, or an area around the local intensity minimum of the deactivation light distribution. The area around the local intensity minimum, in which the excitation light distribution is repositioned, has in particular such a width that the effective detection PSF of the photon emission in the area is not or only minimally influenced by the deactivation light.

By keeping the deactivation light distribution stationary, a less complex and in particular more compact optical setup can be achieved, since no means for simultaneous fast beam displacement of the excitation light beam and the deactivation light beam are necessary. For example, the excitation light can be displaced by means of acousto-optical deflectors (AOD), while the deactivation light beam is displaced, in particular, only more slowly, e.g., by a galvanometric scanner.

According to a further embodiment, light distributions are used for determining the positions, which are generated due to interference of coherent light. This is the case, for example, with a phase modulation of laser light in a plane conjugate to the objective pupil to generate the light distributions in the focus.

According to a further embodiment, the plurality of light distributions is generated using at least one beam shaping device, in particular at least one light modulator, further in particular with a plurality of switchable pixels. The at least one light modulator may be, for example, a phase modulating spatial light modulator (SLM). In particular, these modulators have an active surface with a blazed grating, wherein the switchable pixels are arranged on the active surface, and wherein the individual pixels can be set to a desired phase value by a switching process using liquid crystals. By generating phase patterns such as vortex patterns or concentric rings and circular disks by means of the switchable pixels, intensity distributions such as 2D donuts and 3D donuts can be generated in the focal plane, for example. In particular, the at least one light modulator is arranged in a plane conjugate to an objective pupil. As an alternative to a light modulator, for example, a phase plate can also be provided on which the phase pattern is imprinted.

According to a further embodiment, a region between two local maxima of the deactivation light distribution adjacent to the local intensity minimum of the deactivation light distribution is extended further than a corresponding region between two local maxima of the excitation light distribution adjacent to the local minimum of the excitation light distribution, at least in one spatial direction, particularly by 10% or more, more particularly by 20% or more, more particularly by 30% or more, more particularly by 40% or more, more particularly by 50% or more, more particularly by 60% or more, more particularly by 70% or more, more particularly by 80% or more, more particularly by 90% or more, more particularly by 100% or more, more particularly by 150% or more, more particularly by 200% or more, more particularly by 300% or more, more particularly by 400% or more, more particularly by 500% or more. The width of the deactivation light distribution can be achieved, e.g., by changing the total intensity of the deactivation light and/or by changing the phase pattern imposed on the deactivation light beam. Due to the wider deactivation light distribution compared to the excitation light distribution, it can advantageously be achieved that the effective detection PSF is only minimally influenced by the deactivation light distribution during repositioning of the excitation light distribution.

According to a further embodiment, a light intensity of the deactivation light within the scanning region in which the excitation light distribution, in particular the local minimum of the excitation light distribution, is repositioned is 10% or less, in particular 5% or less, further in particular 4% or less, further in particular 3% or less, further in particular 2% or less, further in particular 1% or less, further in particular 0.5% or less, further in particular 0.4% or less, further in particular 0.3% or less, further in particular 0.2% or less, further in particular 0.1% or less, of a maximum light intensity of the deactivation light. By the maximum light intensity of the deactivation light is meant here the intensity value at a local intensity maximum, which prevails in particular at the position of a local maximum adjacent to the local minimum. In this way, background suppression can be achieved with only a minimal effect of the deactivation light distribution on the effective detection PSF.

According to a further embodiment, a plurality of scanning steps is performed, wherein the local minimum of the excitation light distribution in each of the scanning steps is positioned at a plurality of the scanning positions of a respective scanning region, wherein the respective scanning region of each scanning step comprises a smaller area or volume than the scanning regions of the preceding scanning steps, and the deactivation light distribution is adjusted in at least a part of the scanning steps, particularly depending on the area or volume of the respective scanning area. Therein, in particular, the catch region of the respective scanning step assigned to the respective scanning region also has a smaller area or a smaller volume than the catch region of the preceding scanning step. In particular, further scanning steps can be carried out in the method in which the area or the volume of the scanning region (and in particular also the area or the volume of the catch region) remains constant, in particular towards the end of a localization of a molecule.

According to a further embodiment, a total intensity of the deactivation light distribution is adjusted depending on the area or volume of the respective scanning region, wherein particularly the smaller the area or volume of the respective scanning region, the greater the total intensity.

According to a further embodiment, a shape of the deactivation light distribution is adjusted depending on the area or volume of the respective scanning region, wherein in particular a full width at half maximum of the deactivation light distribution is smaller the smaller the area or volume of the respective scanning region. For this purpose, e.g., the phase pattern used for phase modulation of the deactivation light beam can be modified between the scanning steps, e.g., by controlling the pixels of a light modulator.

According to a further embodiment, the scanning region is a circle or a sphere with a radius around an estimated position of the molecule, wherein the radius has a first value in an initial scanning step in which the excitation light distribution is repositioned several times within the scanning region, and wherein, in particular, the excitation light distribution is repositioned within the scanning region in at least one further scanning step subsequent to the initial scanning step, wherein the radius has a second value smaller than the first value in the at least one further scanning step. This corresponds, for example, to the iterations of a MINFLUX method. In particular, the minimum of the excitation light distribution in each of the scanning steps is successively arranged at a plurality of positions of a coordinate pattern (also referred to as set of targeted coordinates, STC, or targeted coordinate pattern, TCP) arranged within the respective scanning region around an estimated position of the fluorophore. Further, in particular, after each scanning step, an estimated position of the fluorophore is determined from the emitted photons and the corresponding positions of the minimum of the excitation light distribution, wherein in each scanning step the position of the molecule estimated in the previous scanning step defines the center of the scanning region.

According to a further embodiment, the deactivation light distribution remains constant during repositioning of the excitation light distribution. That is, in particular, the total light intensity and the shape of the deactivation light distribution remain constant. In particular, the total intensity and the shape of the deactivation light distribution remain constant over a plurality of scanning steps, in particular over all scanning steps. Alternatively, the deactivation light distribution may be changed during repositioning of the excitation light distribution (or between position changes of the excitation light distribution), i.e., in particular, the shape and/or the total intensity of the deactivation light distribution may change.

According to a further embodiment, after deriving the position of the molecule, the position of at least one further molecule in the sample is determined by illuminating the further molecule with the excitation light distribution, detecting photons emitted by the further molecule for different positionings of the excitation light distribution, and deriving the position of the further molecule based on the photons detected for the different positionings of the excitation light distribution, wherein, prior to determining the position of the further molecule, the local minimum of the excitation light distribution and the local minimum of the deactivation light distribution are positioned, in particular simultaneously, at an expected position of the further molecule. Thereby, the excitation light distribution and the deactivation light distribution can be displaced e.g., together with a scanning device, e.g., a galvanometric scanner, wherein in particular an expected position of the further molecule is arranged in the focal plane in the center of an image of a detection pinhole (i.e., a confocal arrangement is realized with respect to the expected position of the molecule).

According to a further embodiment, a pre-localization of the molecule is performed, wherein an initial estimated position of the molecule is determined, and wherein the sample is illuminated during the pre-localization, in particular only with the excitation light distribution (i.e., not with the deactivation light distribution). In particular, the pre-localization comprises locating the molecule, i.e., identifying a light emitter in a particular sample volume by detecting photons above a background emission. In particular, the localization is performed based on the initial estimated position, and further in particular a center of the initial scanning region is located at the initial estimated position. The pre-localization need not be based on the MINFLUX method, but may also be based, for example, on an independent positioning method of lower accuracy. E.g., pre-localization can be performed using wide-field fluorescence microscopy with camera imaging. Another possibility is confocal scanning of a sample area with an approximately Gaussian focus of the excitation light and detection of the emission light with a point detector. According to a further embodiment, in the pre-localization the sample is illuminated with an excitation light distribution with a local minimum (in particular the same excitation light distribution as in MINFLUX localization), wherein emission light is detected in a position-dependent manner and the initial position of the molecule is determined based on the position-dependent detection. In particular, the position-dependent detection can be performed by moving a projection of a detection pinhole in the sample plane while keeping the position of the excitation light distribution constant (so-called ‘pinhole orbit scan’). For example, the projection of the detection pinhole can be shifted with a first scanning device, e.g., a galvanometric scanner, while a second scanning device, e.g., one or more EODs, is used to correct the position of the excitation light beam such that the position of the excitation light distribution remains constant. Alternatively, an area detector (e.g., an array of avalanche photodiodes) can be used, for example, to determine a distribution of the emission light in a detector plane to determine the initial position of the molecule.

According to a further embodiment, the sample is illuminated with the deactivation light distribution during the pre-localization (e.g., during a pinhole orbit scan or position-dependent detection with an array detector). Advantageously, this can reduce background fluorescence, particularly from planes located along the optical axis above or below the focus of the excitation light, thereby increasing the accuracy of the pre-localization. In particular, a shape of the deactivation light distribution and/or an intensity of the deactivation light is adjusted between the pre-localization and the further localization steps (e.g., MINFLUX steps). In some cases, however, it may also be advantageous to illuminate the sample only with the excitation light during the pre-localization and to illuminate the sample with the deactivation light only during the further localization steps.

According to a further embodiment, the excitation light distribution is displaced relative to the sample with an electro-optical deflector, wherein the deactivation light distribution is displaced relative to the sample with a galvanometric scanner. According to a further embodiment, both the excitation light distribution and the deactivation light distribution are displaced relative to the sample with an electro-optical deflector, in particular together.

According to a further embodiment, the excitation light distribution is formed by irradiating an excitation light beam onto the sample along an optical axis, and/or the deactivation light distribution is formed by irradiating a deactivation light beam onto the sample along an optical axis, particularly along the same optical axis.

According to a further embodiment, the deactivation light distribution is formed as a 2D donut. Here, a 2D donut is understood to mean in particular a light distribution which has a (single) central intensity minimum, in particular a zero point of intensity, the intensity minimum having local intensity maxima adjacent to the intensity minimum in a plane perpendicular to the optical axis. In particular, a 2D donut can be generated by phase modulation with a vortex pattern (from 0 to 2n·π in the circumferential direction with respect to the optical axis, where n is a natural number), in a plane conjugate to the objective pupil, e.g., by means of a phase plate or an SLM. In this process, the phase-modulated light beam is particularly circularly polarized.

According to a further embodiment, the 2D donut is generated by phase modulation of the deactivation light with a first phase pattern, the first phase pattern comprising a phase increasing in a circumferential direction with respect to the optical axis, particularly continuously, from 0 to 2π·n, wherein n is a natural number greater than 1, wherein particularly n≥5. That is, a vortex pattern is generated which runs from phase values of 0 to phase values greater than 2π, namely, e.g., 4π, 6π, 8π or 10π. Advantageously, this allows a wider region of low light intensity to be generated in the focal plane around the local minimum, making it easier to arrange the scanning positions in a region of the deactivation distribution where the intensity is at most three times the saturation intensity. In this context, the excitation light distribution can be generated, for example, by phase modulating the excitation light with a phase pattern that has a phase increasing from 0 to 2π in the circumferential direction, in particular continuously. A vortex pattern with a phase rising from 0 to 10π (or more has proven to be particularly advantageous, since this phase pattern forms a deactivation light distribution with a particularly broad range of low intensity.

A 3D donut (also referred to as a bottle beam) has a (single) central intensity minimum, in particular a zero point of the intensity, which is surrounded by local intensity maxima in all three spatial directions. Thus, the 3D donut forms in particular a minimum surrounded on all sides by intensity increases. The 3D donut can be generated, e.g., by modulation with a first phase pattern comprising concentric rings (or rings and circular disks) of constant phase, which have a phase difference of π with respect to each other. A 3D donut-shaped deactivation light distribution is particularly advantageous for the method according to the invention, since it has a relatively wide range of low light intensity in the focal plane (in the x-y direction), so that the effective emission PSF is little affected by the deactivation light. In particular, the first phase pattern has a circular disk and a first ring arranged concentrically around the circular disk, a second ring arranged concentrically around the first ring, and a third ring arranged concentrically around the second ring, wherein the circular disk and the first ring, the first ring and the second ring, and the second ring and the third ring have a phase difference of π with respect to each other. Advantageously, this results in an intensity distribution stretched in the z-direction.

According to a further embodiment, the deactivation light beam is focused into the sample by means of an objective, wherein a beam cross-section of the deactivation light beam is adjusted, particularly decreased, such that a pupil of the objective lens is under-illuminated so that the deactivation light distribution is stretched in the direction of the optical axis, i.e., in the axial direction. Therein, the plane of the pupil is a Fourier plane of the focal plane in the specimen. The axial stretching of the deactivation light distribution has the advantage that the range in which the deactivation light suppresses background emission (especially background fluorescence) by other molecules in the vicinity of the molecule to be localized is extended in the axial direction. The disturbance of the signal by the background fluorescence is particularly pronounced in the axial direction, so that the quality of localization can be significantly improved by this embodiment. Even if the total intensity of the deactivation light remains constant when the deactivation light distribution is stretched, thereby reducing the light intensity at certain points, this lower intensity may still be sufficient to effectively suppress the background emission, so that the expansion of the axial region has a positive impact despite this effect.

The adaptation of the beam cross-section of the deactivation light beam can be achieved, for example, by means of an aperture stop, in particular an adjustable one, which selectively under-illuminates the objective. Alternatively, for example, an aperture stop can be arranged in the beam path in front of the beam shaping device (in particular the light modulator, e.g., the SLM) to narrow the deactivation light beam before it hits the beam shaping device. Another possibility, in which no light is lost at an aperture, is to narrow the beam cross-section with zoom optics.

According to a further embodiment, the beam cross-section of the deactivation light beam is adjusted by adapting an active surface of a beam shaping device, particularly a light modulator (e.g., an SLM). The active surface of the beam shaping device is configured to impress a phase pattern, in particular an adjustable one, on a light beam that passes through the active surface or is reflected and/or diffracted at the active surface. In particular, the active surface has a blazed grating for diffraction of the deactivation light beam and a plurality of pixels, in particular liquid crystal-based pixels, wherein a phase value of the pixels is adjustable so that an adjustable phase pattern is superimposed on the blazed grating to impress a phase distribution on the diffracted light beam.

According to a further embodiment, an orientation of the blazed grating in an outer region of the active surface of the beam shaping device is adjusted in order to adapt the beam cross-section of the deactivation light beam, in particular adapting a diffraction order of the blazed grating. In particular, the adjustment of the blazed grating results in light incident on the outer region being coupled out of a beam path so that it does not illuminate the sample. In particular, the outer region of the active surface encloses an inner region of the active surface on which, in particular, the first phase pattern is displayed to produce the deactivation light distribution. Thus, the beam cross-section of the deactivation light beam is reduced to the light entering the beam path from the inner region of the active surface.

According to a further embodiment, a second phase pattern is generated on the active surface of the beam shaping device, particularly in addition to the first phase pattern. Therein, the deactivation light distribution is stretched by a phase modulation of the deactivation light beam with the second phase pattern.

According to a further embodiment, the second phase pattern is formed as a ring extending in a circumferential direction to the optical axis, particularly wherein the ring comprises a plurality of segments, wherein adjacent segments respectively comprise a phase difference of π with respect to each other. Such a phase pattern results in a stretching of a light intensity distribution in the focus, which is generated by a first phase pattern arranged within the ring in a plane conjugate to the objective pupil. In particular, the second phase pattern is arranged concentrically around the first phase pattern, further in particular on the outer region of the active surface, the first phase pattern being formed on the inner region of the active surface. E.g., the first phase pattern may be a further ring concentrically arranged around a circular disc, the further ring and the circular disc having a phase difference of π. In this way, for example, a stretched 3D donut can be generated if suitable area ratios are fulfilled. This is particularly well suited for the method according to the invention because it has a relatively wide range of low light intensity in the focal plane (in the x-y direction), so that the effective detection PSF is little affected by the deactivation light but covers an extended range in the axial direction (z direction) to effectively suppress background fluorescence. The excitation light distribution can be e.g., a 3D donut (bottle beam) without additional axial stretching.

According to a further embodiment, both the first phase pattern and the second phase pattern comprise phase values gradually increasing in the circumferential direction from 0 to n·2π (vortex pattern), wherein the first phase pattern is arranged on a circular disk and the second phase pattern is arranged on a ring concentrically arranged around the first phase pattern, and wherein the first phase pattern and the second phase pattern have a phase difference of a·π in a radial direction. Such a phase pattern is described in patent application WO 2019/221622 A1. By adjusting the ratio between the outer radii of the circular disk (first phase pattern) and the ring (second phase pattern), the stretching of the resulting light distribution in the direction of the optical axis and the width of the distribution can be flexibly adjusted.

According to a further embodiment, the first phase pattern comprises a circular disk and a first ring arranged concentrically around the circular disk, wherein the second phase pattern comprises a second ring arranged concentrically around the first ring and a third ring arranged concentrically around the second ring, and wherein the circular disk and the first ring, the first ring and the second ring, and the second ring and the third ring respectively have a phase difference of π from one another. In this way, a 3D donut stretched in the z-direction can also be generated given suitable area ratios.

According to a further embodiment, in particular in addition to the first and/or the second phase pattern, a further, third phase pattern is generated on the active surface of the beam shaping device, the third phase pattern being in particular at least partially superimposed on the first phase pattern. The third phase pattern forms, in particular, a circular disk with a plurality of segments, wherein segments adjacent to one another in each case have a phase difference of π from one another. Advantageously, this allows additional light (e.g., secondary maxima) to be generated in the focal plane in a peripheral region around the focal intensity distribution, which can improve the suppression of background emission. In particular, the third phase pattern overlaps with the first phase pattern in a central subregion or is arranged radially within the first phase pattern.

According to a further embodiment, the first phase pattern has the form of a circular disc with a phase rising in the circumferential direction in a vortex-like manner from 0 to 2n·π the third phase pattern being formed by a plurality of circular disc segments extending in the center of the circular disc over a partial area of the circular disc, wherein an additional phase jump of

$$+ \frac{π}{2} or - \frac{π}{2}$$

is superimposed on the first phase pattern in the segments by means of the second phase pattern. In this way, in combination with a circular polarizing element, a (possibly broadened) 2D donut with additional secondary maxima can be generated.

According to a further embodiment, the third phase pattern has the form of a circular disk with a plurality of segments, wherein adjacent segments have a phase difference of π with respect to each other, wherein the first phase pattern comprises a first ring arranged concentrically around the third phase pattern and a second ring arranged concentrically around the first ring, and wherein the first ring and the second ring have a phase difference of π with respect to each other. If suitable area ratios of the first and second rings and in particular of the segments are maintained, a 3D donut with additional secondary maxima can be generated in the focal plane in this way.

According to a further embodiment, the deactivation light beam is formed at least approximately as a Bessel beam. Such a light beam can be generated, for example, by focusing the deactivation light with an axicon or by phase modulation of the deactivation light with a, in particular, annular phase pattern. The generation of a hollow Bessel-like STED beam is known from the prior art (see, e.g., P. Zhanq, P. Goodwin, J. Werner: ‘Fast, super resolution imaging via Bessel beam stimulated emission depletion microscopy’, Opt. Expr. 22, 12398 (2014); W. Yu, Z. Ji, D. Dong, X. Yang, Y. Xiao, X. Gong, P. Xi, and K. Shi: ‘Super-resolution deep imaging with hollow Bessel beam STED microscopy’, Laser & Photonics Review, 10 (1), 146-152, January 2016).

A second aspect of the invention relates to a device, particularly a microscope, for determining positions of molecules spaced apart from one another in one or more spatial directions in a sample, particularly according to a method according to the first aspect. The device comprises at least one light source for generating an excitation light beam and a deactivation light beam, particularly a STED beam, and at least one beam shaping device for forming an excitation light distribution from the excitation light beam and a deactivation light distribution from the deactivation light beam, wherein the excitation light distribution and the deactivation light distribution each comprises a local intensity minimum and intensity increasing regions adjacent thereto. The device further comprises an optical arrangement for illuminating the sample with the excitation light distribution and the deactivation light distribution, at least one detector for detecting photons emitted by the molecule for different positionings of the excitation light distribution, and a computing unit for deriving the position of the molecule based on the photons detected for the different positionings of the excitation light distribution.

In particular, the device comprises at least one beam deflection device configured to successively arrange the local minimum of the excitation light distribution at a plurality of scanning positions within a scanning region, wherein the device further comprises a control unit configured to adjust the light intensity of the deactivation light in a catch region assigned to the scanning region, in which the position of the molecule can be unambiguously derived from the scanning positions and the associated detected photons, to at most three times a saturation intensity, particularly to at most twice the saturation intensity, more particularly to at most the saturation intensity, further particularly to at most 50% of the saturation intensity, further particularly to at most 45% of the saturation intensity, further particularly to at most 40% of the saturation intensity, further particularly to at most 35% of the saturation intensity, further particularly to at most 30% of the saturation intensity, further particularly to at most 25% of the saturation intensity, further particularly to at most 20% of the saturation intensity, further particularly to at most 15% of the saturation intensity, further particularly to at most 10% of the saturation intensity, further particularly to at most 5% of the saturation intensity, of the deactivation light. For this purpose, the control unit controls in particular the light source that generates the deactivation light or a separate device for adjusting the intensity of the deactivation light.

In particular, the device is configured to form the excitation light distribution and the deactivation light distribution during the different positionings of the excitation light distribution such that an effective detection PSF, in particular a width of the effective detection PSF, is unaffected by the deactivation light distribution.

According to a further embodiment, the at least one beam deflection device is configured to reposition the excitation light distribution relative to the deactivation light distribution, particularly wherein the at least one beam deflection device is configured to position the local minimum of the excitation light distribution differently more than once within a vicinity of the local intensity minimum of the deactivation light distribution. In particular, the at least one beam deflection device comprises a scanning device, in particular a galvanometric scanner, which is configured to reposition the excitation light distribution and the deactivation light distribution together relative to the sample, wherein the at least one beam deflection device further comprises a lateral beam deflection device, in particular comprising at least one electro-optical or acousto-optical deflection unit, which is adapted to reposition the excitation light distribution relative to the deactivation light distribution.

According to a further embodiment, the at least one beam deflection device is configured to reposition the excitation light distribution while leaving the deactivation light distribution stationary, such that the local minimum of the excitation light distribution is positioned differently more than once within a vicinity of the local intensity minimum of the deactivation light distribution.

According to a further embodiment, the at least one beam deflection device is configured to reposition the excitation light distribution and the deactivation light distribution together.

According to a further embodiment, the at least one beam shaping device is configured to form a region between two local maxima of the deactivation light distribution adjacent to the local intensity minimum of the deactivation light distribution extended further, in particular at least 10% further, further in particular at least 20% further, at least in one spatial direction than a corresponding region between two local maxima of the excitation light distribution adjacent to the local minimum of the excitation light distribution.

According to a further embodiment, the device is configured to perform a plurality of scanning steps, wherein the at least one beam deflection means is configured to position the local minimum of the excitation light distribution in each of the scanning steps at a plurality of the scanning positions of a respective scanning region, wherein the respective scanning region of each scanning step has a smaller area or volume than the scanning regions of the preceding scanning steps, and wherein the at least one beam shaping device or the control unit is adapted to adjust the deactivation light distribution in at least a part of the scanning steps depending on the area or volume of the respective scanning region, wherein the at least one beam shaping device is adapted to adapt an total intensity and/or a shape of the deactivation light distribution in dependence on the area or the volume of the respective scanning region.

According to a further embodiment, the at least one beam shaping device or the control unit is configured to keep the deactivation light distribution constant during repositioning of the excitation light distribution.

According to a further embodiment, the device is adapted to determine the position of at least one further molecule in the sample after deriving the position of the molecule, wherein the excitation light source and the at least one beam shaping device are configured to illuminate the further molecule with the excitation light distribution, and wherein the detector is configured to detect photons emitted by the further molecule for different positionings of the excitation light distribution, and wherein the computing unit is configured to derive the position of the further molecule on the basis of the photons detected for the different positionings of the excitation light distribution, wherein the at least one beam deflection device is configured to position the local minimum of the excitation light distribution and the local minimum of the deactivation light distribution at an expected position of the further molecule prior to determining the position of the further molecule.

According to a further embodiment, the device comprises a first beam shaping device, particularly a first light modulator or a first phase plate, for generating the excitation light distribution, and a second beam shaping device, particularly a second light modulator or a second phase plate, for generating the deactivation light distribution independently of the generation of the excitation light distribution. Alternatively, the light distributions can be generated, for example, by two spatially separated regions of a single light modulator.

According to a further embodiment, the beam shaping device comprises an active surface for generating a phase pattern, the beam shaping device being configured in particular as a light modulator or phase plate.

According to a further embodiment, the at least one beam shaping device is configured to form the deactivation light distribution as a 2D donut.

According to a further embodiment, the at least one beam shaping device is adapted to generate the first phase pattern, the second phase pattern and/or the third phase pattern on its active surface.

According to a further embodiment, the first phase pattern comprises a phase increasing in a circumferential direction with respect to the optical axis, in particular continuously, from 0 to 2n·π, in particular wherein n is a natural number which is greater than 1. Therein, the device particularly comprises a circular polarizing element, in particular an λ/4 plate, in a beam path between the beam shaping device and the objective.

According to a further embodiment, the device comprises a control unit, wherein the control unit is configured to control the beam shaping device such that the first phase pattern is modified, in particular such that a shape of the deactivation light distribution is adapted in dependence on the area or volume of the respective scanning region, in particular in the scanning steps.

According to a further embodiment, the at least one beam shaping device is configured to form the deactivation light distribution as a 3D donut.

According to a further embodiment, the at least one beam shaping device is configured to generate on its active surface a first phase pattern comprising concentric rings of constant phase having a phase difference of π with respect to each other.

According to a further embodiment, the device comprises an objective for focusing the deactivation light beam (and in particular also the excitation light beam) into the sample, the device further comprising an adjustable aperture stop in a beam path between the deactivation light source and the beam shaping device or a zoom optics for reducing the beam cross-section of the deactivation light beam, wherein the device comprises a control unit configured to control the aperture stop or the zoom optics to adjust a beam cross-section of the deactivation light beam so as to under-illuminate a pupil of the objective so that the deactivation light distribution is stretched in the direction of the optical axis (i.e., in the axial direction).

According to a further embodiment, the device comprises an optical unit configured to form the deactivation light beam at least approximately as a Bessel beam. In particular, the optical unit comprises an axicon or an SLM for forming or beam shaping the deactivation light beam as a Bessel beam.

According to a further embodiment, the control unit is configured to adapt the active surface of the beam shaping device, in particular of the light modulator, such that the beam cross section of the deactivation light beam is adapted, in particular reduced, by adapting the active surface.

According to a further embodiment, the control unit is configured to adjust an orientation of a blazed grating in an outer region of the active surface of the beam shaping device so that the beam cross-section of the deactivation light beam is adjusted, in particular reduced.

A third aspect of the invention relates to a method for localizing single molecules of a fluorescent dye in a sample comprising the steps of

photoactivating one or more molecules of a fluorescent dye from a protected, non-fluorescent form into an activated, fluorescent form by illumination with activation light,

determining initial position estimates of one or more activated dye molecules,

forming an intensity distribution of an excitation light and an intensity distribution of a—fluorescence prevention light in the sample, wherein the intensity distribution of the excitation light and the intensity distribution of the fluorescence prevention light each comprise a local intensity minimum,

scanning the sample or a section of the sample with the excitation light distribution at a sequence of scanning positions,

detecting a photon count or an intensity of fluorescent light at each scanning position of the sequence and associating the photon count or the intensity with the respective scanning position,

determining a new position estimate of the one or more activated dye molecules from the associated photon counts or intensities of the fluorescent light and the scan positions,

wherein in particular the local intensity minimum of the excitation light distribution is arranged successively at the scanning positions, wherein the light intensity of the fluorescence prevention light in a catch region associated with the scanning region, in which the position of the molecule can be unambiguously derived from the scanning positions and the associated detected photons, is at most three times a saturation intensity, in particular at most twice the saturation intensity, further in particular at most the saturation intensity, further in particular at most 50% of the saturation intensity, further in particular at most 20% of the saturation intensity, further in particular at most 10% of the saturation intensity, of the fluorescence prevention light.

According to one embodiment, the position of the intensity distribution of the fluorescence prevention light is stationary during scanning with the intensity distribution of the excitation light at the scanning positions, each associated with an activated fluorescent dye molecule.

During scanning, the intensity distribution of the fluorescence prevention light particularly remains stationary, and the intensity distribution of the excitation light is sequentially positioned at a plurality of scanning positions. From the fluorescence intensities and the scanning positions, new position estimates of the fluorescence molecules are calculated compared to previous position estimates. The new position estimates, when stationary fluorescent dye molecules are localized, are improved position estimates, i.e., those that estimate the actual position of the fluorescent dye molecule in question with less uncertainty. If moving fluorescent dye molecules are observed, they may be values that each estimate a new, changed position of the fluorescent dye molecule of interest.

The fluorescence prevention light comprises an intensity distribution with a local intensity minimum and prevents or suppresses the emission of fluorescence in areas outside this local intensity minimum. Therein, the focus is not on reducing the volume of an effective PSF in the sense of increasing resolution as in STED microscopy, but rather primarily on suppressing unwanted fluorescence of dye molecules from focal edge regions or other planes of the sample. As a result, the detection of fluorescence can be limited to a fluorescent dye molecule located near the local intensity minimum, and unwanted contributions from other fluorescent dye molecules, particularly from focal edge regions or other planes of the sample, can be suppressed. Thus, unlike in STED microscopy, it may even be explicitly desirable to make the intensity minimum as broad as possible and the intensity increase near the intensity minimum as flat as possible, so as to have little effect on the fluorescence emission of a fluorescent dye molecule located near the intensity minimum when the intensity minimum is shifted. Such a broad-zero intensity distribution can be generated, for example, by phase modulating the fluorescence prevention light beam with a higher-order vortex phase plate whose phase delay does not vary from 0 to 2π with the orbital angle (as is common in STED microscopy), but from 0 to 4π or a higher multiple of 2π. Alternatively, a corresponding phase pattern can be generated by a light modulator with switchable pixels to impose the appropriate phase distribution on the fluorescence prevention light. Notwithstanding the foregoing, however, an increase in resolution by the fluorescence preventing light in the sense of STED microscopy may also be advantageous and desirable in individual embodiments of the method.

Embodiments of the method include combining point-focused excitation light with a toroidal intensity distribution of fluorescence prevention light and combining two toroidal intensity distributions of excitation and fluorescence prevention light.

According to one embodiment, the method comprises selecting a fluorescent dye that is convertible from a protected, non-fluorescent form to an activated, fluorescent form by illumination with an activation light, and photoactivating one or more molecules of the fluorescent dye from the protected, non-fluorescent form to the activated form by illumination with activation light.

According to one embodiment, the method comprises a first group of method steps comprising the steps of

photoactivating one or more molecules of a fluorescent dye from a protected, non-fluorescent form into an activated, fluorescent form by illumination with activation light,

determining initial position estimates of one or more activated dye molecules; and

forming an intensity distribution of an excitation light and an intensity distribution of a fluorescence prevention light in the sample, wherein the intensity distribution of the excitation light and the intensity distribution of the fluorescence prevention light each comprise a local intensity minimum,

and/or and a second group of process steps comprising the steps of

scanning the sample or a section of the sample with the excitation light distribution at a sequence of scanning positions, the sequence containing subsets each having at least two scanning positions which are arranged at a distance of less than d/2 around the position estimate of an activated dye molecule associated with the subset,

detecting a photon number or an intensity of fluorescent light at each scanning position of the sequence and associating the photon number or the intensity with the respective scanning position; and

determining a new position estimate for each of the activated dye molecules associated with a subset from the associated photon counts or intensities of the fluorescent light and the scanning positions.

According to a further embodiment, one or more molecules of the fluorescent dye that are spaced apart by a minimum distance d from each other, are photoactivated from the protected, non-fluorescent form into the activated form by illumination with the activation light.

According to a further embodiment, the initial position estimates of the one or more activated dye molecules are determined with an uncertainty of no more than d/2 where d is the minimum distance between the molecules.

According to a further embodiment, the sequence of scanning positions includes subsets of at least two scanning positions each, wherein the at least two scanning positions are spaced less than d/2 around the position estimate of an activated dye molecule associated with the subset, wherein d is the minimum distance between the molecules.

According to a further embodiment, the new position estimate for each of the activated dye molecules associated with a subset is determined from the associated photon numbers or intensities of the fluorescent light and the scanning positions.

According to a further embodiment, the value of d is such that initial position estimates can be unambiguously assigned to the activated fluorescent dye molecules and that the detected fluorescent light at each scanning position originates from only one activated molecule of the fluorescent dye at a time.

According to a further embodiment, the minimum distance between the molecules, d, is 250 nm or greater.

According to a further embodiment, the scanning positions of the sequence of scanning positions are arranged on circular paths, spiral paths or spherical shells.

According to a further embodiment, the second group of process steps is carried out repeatedly.

According to a further embodiment, a total intensity of the intensity distribution of the excitation light and/or the fluorescence prevention light having a local intensity minimum is increased between repetitions, and the scanning positions of the subsets are shifted in the direction of the respective current position estimate of the associated activated fluorescence molecule.

According to a further embodiment, the last determined position estimate has an uncertainty of at most d/10 and preferably of at most d/30 in at least one spatial direction, wherein d is the minimum distance between the molecules.

According to another embodiment, a movement of individual molecules of the fluorescent dye in a sample or the sample is tracked.

According to a further embodiment, the total intensity of the intensity distribution of the excitation light and/or the fluorescence prevention light having a local intensity minimum is reduced between two repetitions and the scanning positions of the subsets are shifted towards a position estimate of the associated activated fluorescence molecule determined by temporal extrapolation.

According to a further embodiment, the first and second groups of process steps are carried out repeatedly in total, with the respective activated dye molecules being converted to a non-fluorescent state between the repetitions.

According to a further embodiment, a high-spatial-resolution image of a structure in the sample is reconstructed from the localizations of the individual molecules of the fluorescent dye.

According to a further embodiment, the activation light is used to form a plurality of illumination spots in the sample.

According to a further embodiment, the illumination spots are arranged on a regular grid.

According to one embodiment, the determination of position estimates of a single activated dye molecule is performed multiple times, for example at fixed intervals. If the method is carried out to track the movement of a dye molecule in a sample, the scanning positions for a determination step are determined based on the position estimate of the preceding determination step, as may also be the case in the localization of non-moving dye molecules. In the case of tracking molecules, the spacing of the scanning positions is advantageously adapted to the speed and nature of the movement of the dye molecules, especially if these are known from the preceding determination steps. If the movement is fast and random, large spacings of the scanning positions are chosen so that the molecule is reliably located in each case within the range defined by the scanning positions in which the position of a molecule can be estimated. If, on the other hand, the motion is slow and directional, for example, the spacing of the scanning positions is chosen to be smaller, but also such that molecule is reliably located in each case within the range defined by the scanning positions in which the position of a molecule can be estimated. In both cases, the center of the set of scanning positions is moved to the location where the molecule is expected to be during the next sequence of scanning steps. In the case of random motion, this is the location corresponding to the most recently determined position estimate. From the successively determined position estimates, a trajectory of the dye molecule can be reconstructed, visualized and, if necessary, further analyzed. When using the dye as a marker for a biomolecule, for example a protein or a lipid, such trajectories are suitable for studying dynamic cellular processes in which the labeled biomolecule is involved. In addition to the high spatial resolution, the method according to the invention also allows a considerably faster determination of the positions of single molecules than is possible with methods known from the prior art, thus extending the applicability of single molecule tracking to fast dynamic processes.

According to a further embodiment, two intensity distributions of excitation and fluorescence prevention light, each having an intensity minimum, are superimposed, wherein the sample or the section of the sample is scanned at least with the excitation light. Provided that the fluorescence prevention light remains at a stationary position when scanning one activated dye molecule at a time, the fluorescence prevention light serves quite predominantly only to suppress fluorescence contributions from regions outside the intensity minima; for this purpose, an intensity distribution with an intensity minimum as broad as possible is particularly advantageous. From the fluorescence signals detected at the scanning positions, previously determined position estimates of the activated dye molecules can be improved, i.e., the activated dye molecules can be localized with increasing accuracy. The scanning is preferably adaptive, i.e., the scanning positions are determined taking into account the fluorescence signals detected at previous scanning positions, while simultaneously increasing the total intensity of the excitation light. In this way, the localization of the dye molecules can be performed with an uncertainty of a few nanometers. According to the described embodiment, the scanning can optionally be performed by excitation light and fluorescence prevention light together; in this case, the fluorescence emission at the scanning positions is modulated by the excitation and the fluorescence prevention light.

A fourth aspect of the invention relates to a device, in particular a microscope, for generating spatially high-resolution images of a structure in a sample, in particular according to a method according to the third aspect of the invention. The device may be constructed analogously to the device according to the second aspect of the invention.

Advantageous further developments of the invention result from the claims, the description and the drawings. The claims are not to be understood to mean that only those objects, devices or methods which in each case have only all or none of the features of a subclaim in addition to the features of independent claims 1 and 13 can be possible further embodiments of the invention. Rather, further embodiments may result from features mentioned in the description as well as from features which can be taken from the drawings and which may take effect individually or cumulatively. Thus, in particular, the embodiments of the first and second aspects can also be freely combined with the embodiments of the third and fourth aspects of the invention, respectively.

### BRIEF DESCRIPTION OF THE FIGURES

In the following, the invention is further explained and described with reference to preferred embodiments shown in the figures.

FIG. 1 shows schematically the sequence of the method according to the invention;

FIG. 2 schematically shows several steps of a MINFLUX localization method;

FIG. 3 shows a device for determining positions of a molecule according to a first embodiment of the present invention;

FIG. 4 shows a device for determining positions of a molecule according to a second embodiment of the present invention;

FIG. 5 shows a beam shaping device as part of a device according to an embodiment of the invention;

FIG. 6A-D show different phase patterns for generating deactivation light distributions and corresponding contour plots generated by simulations;

FIG. 7A-D shows additional phase patterns for generating deactivation light distributions and corresponding simulated contour plots;

FIGS. 8A-D show plots of an excitation light distribution and various deactivation light distributions along a direction in the focal plane;

FIGS. 9A-D show a further phase pattern for generating a deactivation light distribution as well as different plots of the deactivation light distribution generated by the phase pattern and an excitation light distribution;

FIG. 10A-E show a further phase pattern for generating a deactivation light distribution, and various plots of the deactivation light distribution generated by the phase pattern compared to a bottle beam distribution.

### FIGURE DESCRIPTION

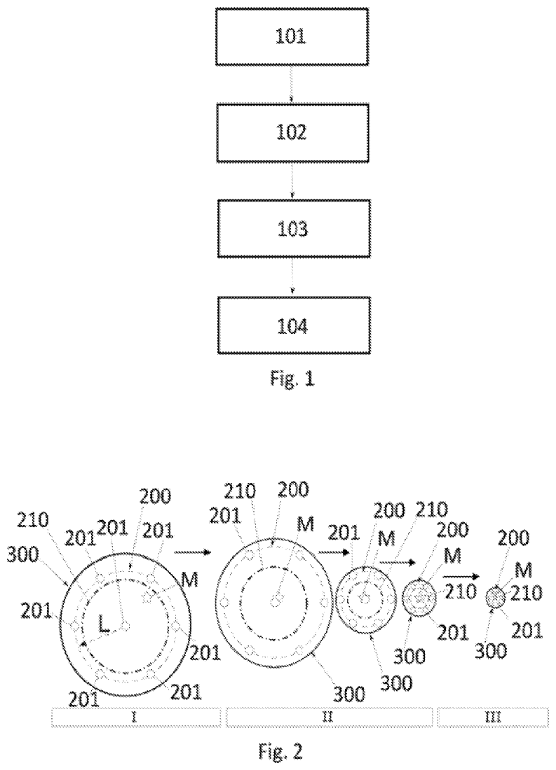

FIG. 1 illustrates the sequence of the method according to the invention as a block diagram. The method is in particular a MINFLUX localization with additional deactivation (e.g., STED) light.

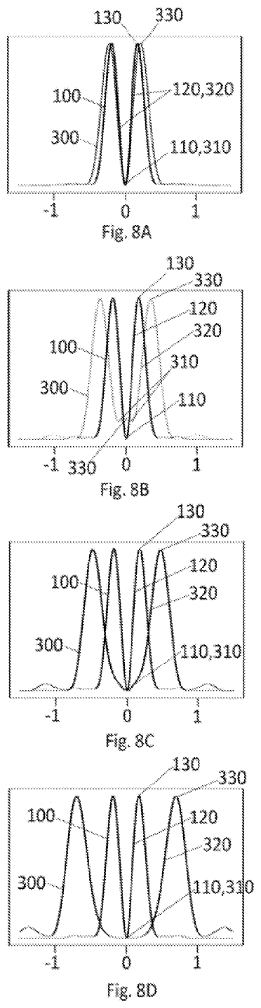

In step 101, an excitation light distribution 100 and a deactivation light distribution 300, in particular a STED light distribution, are generated. Both light distributions have a local intensity minimum 110, 310 and intensity increasing areas 120, 320 adjacent thereto (see also FIG. 8). Around the respective local intensity minimum 110, 310, the light distributions each have a region of relatively low light intensity. Therein, this region of the deactivation light distribution 300 is in particular wider than the corresponding region of the excitation light distribution 100. In particular, the deactivation light distribution 300 forms a jacket around a region of the excitation light distribution 100.

According to step 102, the sample 20 is illuminated with the excitation light distribution 100 and the deactivation light distribution 300 so that a molecule M to be localized in the sample 20 is excited by the excitation light and accordingly emits photons, while the deactivation light suppresses the emission of background photons from other molecules M in the sample 20.

In step 103, photons emitted by the molecule are detected for different positionings of the excitation light distribution 100 using a detector, such as a point detector confocal to the focus.

Finally, in step 104, the position of the molecule M is determined based on the photons detected for the different positionings of the excitation light distribution 100, e.g., using a maximum likelihood estimator. In particular, the method is performed such that the excitation light distribution 100 and the deactivation light distribution 300 during the different positionings of the excitation light distribution 100 are such that an effective detection PSF, in particular a width of the effective emission point spread function, is unaffected by the deactivation light distribution 300, i.e., is only affected by the excitation light distribution. This improves localization while suppressing background emission. Of course, the representation of FIG. 1 as a block diagram does not mean that the individual steps of the method are necessarily carried out one after the other.

FIG. 2 shows an embodiment of the method according to the invention, which is a MINFLUX localization, in particular performed in several iterations, wherein the minimum 110 of the excitation light distribution 100 is arranged in each iteration at a plurality of scanning positions 201 in a scanning region 200 around a previously determined estimated position of the molecule M. The scanning region 200 is defined as a circle with a radius L around an estimated position of the molecule to be localized. The position estimate selected as the center of the scanning region 200 in the initial step can be determined by an independent method (e.g., PALM/STORM microscopy, confocal scan with Gaussian excitation light distribution, or pinhole orbit scan). Thereafter, in particular, the position estimate determined in the previous MINFLUX iteration is used as the center of the circle in each case.

The scanning positions 201 of an iteration form a so-called set of targeted coordinates (STC, or target coordinate pattern, TCP). In particular, the individual scanning positions 201 may be located on a circle with radius L around the estimated position of the molecule M, wherein the scanning positions 201 are particularly arranged symmetrically around the center. Further, in particular, the estimated position of the molecule M is also used as a scanning position 201. In analogy to the example shown in two dimensions, the sample 20 can be scanned in three dimensions with scanning positions 201 located on or within a sphere of radius L to perform a three-dimensional localization of the molecule M (3D MINFLUX). To shift the excitation light distribution 100 (and in particular also the deactivation light distribution 300) in the z-direction (along the optical axis), a deformable mirror can be used, for example. In particular, a catch region 210 is located within the scanning region 200, wherein the molecule M can be unambiguously localized by means of the method according to the invention, provided that it is located within the catch region 210.

As shown in FIG. 2, the radius L can become smaller in each step, so that the accuracy of the position estimate also increases in each step, at least as long as the molecule M is located in the corresponding reduced scanning region 200. The procedure is typically carried out until the molecule M loses its emissivity (e.g., due to bleaching or a transition to a dark state in the case of fluorophores) or, if possible, until the accuracy of the position estimate approaches a threshold value given by the signal-to-noise ratio. In particular, the whole procedure is then repeated with several further molecules M. A high-resolution image of the sample comprising the multiple localized molecules M can then be calculated from the multiple localizations. The described reduction of the scanning region 200 also results in a smaller catch region 210 in each case than in the previous iteration step.

In FIG. 2, the deactivation light distribution 300 is further schematically shown as a circle concentrically arranged around the scanning region 200. At the position marked by the circle, the intensity of the deactivation light may correspond to, for example, the saturation intensity or a lower value.

As shown in FIG. 2, the deactivation light distribution 300 may remain stationary during at least one MINFLUX iteration, and in particular across multiple MINFLUX iterations, while the excitation light distribution 100 is moved around the local minimum 310 of the deactivation light distribution 300 within a region of lower deactivation light intensity to head for the the scanning positions 201. This has the advantage that fast beam deflection devices such as EODs need only be provided for the excitation light beam, which reduces the complexity of the device and allows for a more compact design. In particular, the deactivation light distribution 300 is then arranged in the center of a projection of a detection pinhole aperture into the focal plane in a corresponding sample region at the beginning of each new localization of a molecule M, in particular by a galvanometric scanner (slower compared to EODs but present anyway). In particular, the deactivation light distribution 300 can be adjusted between iteration steps such that an area where, for example, the saturation intensity of the deactivation light or a lower light intensity prevails, becomes smaller in each iteration step as the scanning region 200 is reduced (see FIG. 2). This can be achieved, in particular, by controlling the total intensity of the deactivation light or by varying the beam shaping (e.g., different phase patterns on an SLM).

Alternatively, the excitation light distribution 100 may be moved together with the deactivation light distribution 300, so that in each iteration the local minima of the two light distributions are arranged together in succession at the scanning positions 201. Due to the required scanning speed, this is performed in particular by means of a common beam deflection with electro-optical or acousto-optical deflectors.

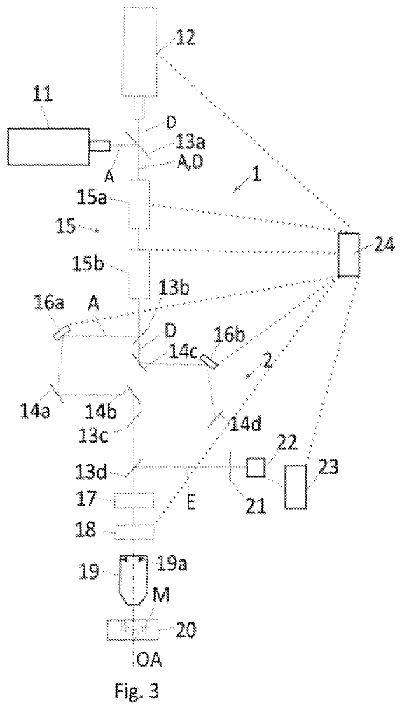

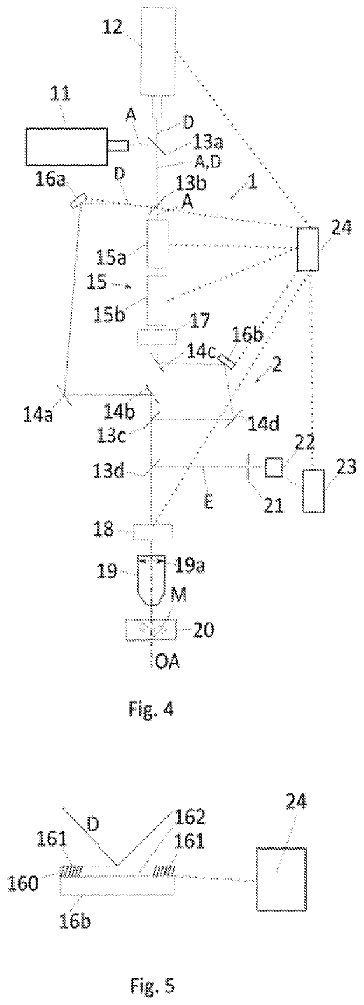

FIGS. 3 and 4 show embodiments of a device 1 according to the invention for determining positions of a molecule M in the form of a MINFLUX microscope with an additional deactivation (in particular STED) light source. The basic principle of the device is first explained with reference to FIG. 3. Subsequently, differences of the embodiment according to FIG. 4 compared to the embodiment according to FIG. 3 are discussed.

FIG. 3 shows a device 1 with a first light source 11, in particular a laser source, for generating a coherent excitation light beam A and a second light source 12, in particular a laser source, for generating a coherent deactivation light beam D. Therein, the light from the first light source 11 has a suitable wavelength for exciting the molecules M in the sample, and the second light source 12 generates light of a wavelength suitable for deactivating the molecules M so that the molecules can no longer emit photons when the excitation light is irradiated (e.g. depletion by stimulated emission, i.e. STED). The wavelengths of the excitation light and the deactivation light are particularly different from each other. As an alternative to two separate light sources 11, 12, the device 1 may also comprise only one light source, in particular a laser source, which generates both the excitation light and the deactivation light. For this purpose, the light source may, e.g., generate a continuum of wavelengths from which excitation light and deactivation light of suitable wavelengths are then obtained, for example by means of optical filters.

In the example shown in FIG. 3, the excitation light beam A and the deactivation light beam D are coupled into a common beam path at a first, particularly dichroic, beam splitter 13a. The light beams then pass together through a lateral beam deflection device 15, which consists of two beam deflection units 15a,15b arranged in series in the beam path. The beam deflection units 15a,15b may be electro-optical deflectors, e.g., the first beam deflection unit 15a being designed to deflect the light beams passing through it in a first direction x perpendicular to the optical axis OA, and the second beam deflection unit 15b being designed to deflect the light beams passing through it in a second direction y perpendicular to the optical axis OA and perpendicular to the first direction. In a manner known from the prior art, the lateral beam deflection device 15 particularly comprises further optical components, in particular lenses for focusing the light beams, which are not shown here for the sake of clarity.

At a second, particularly dichroic, beam splitter 13b, the excitation light beam A and the deactivation light beam D are then split into two parallel beam paths. The excitation light beam A impinges on a first beam shaping device 16a, particularly a first light modulator, further in particular a phase modulating spatial light modulator SLM with controllable pixels. By diffraction of the excitation light beam A at a blazed grating of an active surface of the light modulator, a phase pattern set by means of the controllable pixels is impressed on the excitation light beam A, resulting in formation of the excitation light distribution 100 with the local minimum 110 in the focal plane in the sample 20 by interference. The phase-modulated excitation light beam A is coupled into the main beam path via a first mirror 14a and a second mirror 14b.

In an analogous manner, the deactivation light beam D is directed via a third mirror 14c onto a second beam shaping device 16b, particularly a second light modulator, which imparts to it a preset phase pattern which may differ in particular from the phase pattern of the first beam shaping device 16a. The phase-modulated deactivation light beam D is then deflected via a fourth mirror 14d and then combined with the phase-modulated excitation light beam A via a third, particularly dichroic, beam splitter 13c. Of course, a configuration is also possible in which the deactivation light beam D is coupled into the main beam path via mirrors and the excitation light beam A is combined with the deactivation light beam D via a beam splitter.

Alternatively to the first light modulator 16a and the second light modulator 16b, phase plates with fixed predetermined phase patterns can be used, e.g., which are then typically traversed by the respective light beams (instead of diffraction at a grating of the active surface of the light modulator) in order to impress the respective phase patterns thereon. In addition, optical elements can be arranged in front of the beam shaping devices 16a,16b which influence the polarization direction of the respective light beams, e.g., λ/2 plates (not shown). Furthermore, especially when imposing a vortex phase pattern to generate a 2D donut, a circular polarizing element (e.g., an λ/4 plate) can be provided in the beam path behind the beam shaping devices 16a,16b to achieve the desired light distribution in the focus (not shown).

In particular, the beam shaping devices 16a,16b are each arranged in a plane perpendicular to the optical axis OA, which is conjugate to a pupil of the lens 19. Particularly in the case of light modulators, a slight deviation from this position can also be corrected by adjusting the phase pattern accordingly.

By means of the beam shaping devices 16a, 16b, in particular different phase patterns are imposed on the excitation light beam A and the deactivation light beam D, in particular so that a broader low intensity region (e.g., below the saturation intensity) around the local minimum 310 results in the focal plane for the deactivation light distribution 300 than for the excitation distribution 100. For example, for a 2D MINFLUX localization, the excitation light distribution 100 could be formed as a 2D donut generated by a vortex phase distribution between 0 and 2π, while the deactivation light distribution is formed as a wider 2D donut generated by a vortex phase distribution between 0 and 4π, 6π, 8λ, or 10λ. Similarly, it is possible, for example, that for 3D MINFLUX localization, an excitation light distribution 100 and a deactivation light distribution 300 are each in the form of a 3D donut, with the 3D donut of the deactivation light additionally being axially stretched.

In the common beam path of the excitation light beam A and the deactivation light beam D there is furthermore an axial beam deflection device 17, e.g., comprising a deformable mirror. With the aid of the axial beam deflection device 17, the excitation light beam A and the deactivation light beam D can be displaced together in the z-direction, i.e., parallel to the optical axis OA, e.g., in order to head for scanning positions 201 in the sample in the z-direction for a 3D localization of the molecule M.

Finally, a scanning device 18, e.g., a galvanometric scanner, is arranged in the beam path to scan the excitation light beam A and the deactivation light beam D together across the sample 20. The excitation light beam A and the deactivation light beam D are focused by an objective 19 having a pupil 19a into a sample 20 containing molecules M to be localized, which are spaced apart from each other. At least the objective 19 and the scanning device 18 thereby particularly form an optical arrangement 2 for illuminating the sample 20 with the excitation light distribution 100 and the deactivation light distribution 300. The excitation light beam A and the deactivation light beam D enter the objective 19 along an optical axis.

Due to the excitation with the excitation light, the molecules emit photons (e.g., fluorescent light). The light E emitted by the sample 20 is descanned by the scanning device 18 and coupled into a detection beam path via a fourth, particularly dichroic, beam splitter 13d. In this detection beam path, there is in particular a pinhole 21 which is arranged confocal to the focus of the excitation and deactivation light beam in the sample 20. Behind the pinhole 21 a detector 22, in the example shown here a point detector, e.g., an avalanche photodiode or a photomultiplier, is arranged, which detects and in particular counts the photons emitted by the molecule M.

Furthermore, the device 1 comprises a computing unit 23 which is in electrical connection or data connection with the detector 22 and is configured to determine the position of the molecule M from the photons detected by the detector 22 and the associated positions of the local minimum 110 of the excitation light distribution 100, for example by means of a maximum likelihood estimator implemented on the software or hardware side on the computing unit 23. In order to obtain the positions of the excitation light distribution 100 belonging to the detected photon numbers or photon count rates, the computing unit 23 particularly receives a signal from the control unit 24 or, e.g., directly from the lateral beam deflection device 15, the axial beam deflection device 17 and/or the scanning device 18.

The control unit 24 is further configured to control the lateral beam deflection device 15, the axial beam deflection device 17, the scanning device 18, and the beam shaping devices 16a and 16b.

With the device 1 shown in FIG. 3, the method according to the invention is carried out in particular in such a way that the excitation light beam A and the deactivation light beam D are moved together relative to the sample 20 in a plurality of MINFLUX iterations by means of the lateral beam deflection device 15 (and optionally also by means of the axial beam deflection device 17). In this process, the scanning positions 201 (see FIG. 2) are scanned with the local minimum 110 of the excitation light distribution 100, and by means of the detector 22 the photons emitted by the molecule M are detected for each scanning position 201. Then, for each MINFLUX iteration, an estimated position of the molecule M is determined by means of the computing unit 23 from the detected photons and the corresponding positions of the excitation light distribution 100.

FIG. 4 shows a device 1 according to the invention, which differs from the device 1 shown in FIG. 3 in that the lateral beam deflection device 15 and the axial beam deflection device 17 are arranged in a partial beam path via which the excitation light beam A is directed onto the sample 20. The deactivation light beam D, on the other hand, is guided on a parallel partial beam path without corresponding beam deflection devices. The light beams A, D are split between the partial beam paths by means of the second, particularly dichroic, beam splitter 13b and are recombined via the third, particularly dichroic, beam splitter 13c. The beam shaping devices 16a,16b described in connection with FIG. 3 are also located in the corresponding partial beam paths.

When using the embodiment of the device 1 shown in FIG. 4, in particular prior to the localization of a molecule M, the excitation light beam A and the deactivation light beam D are jointly directed by means of the scanning device 18 onto a region of the sample 20 in which the molecule M to be localized is suspected according to a pre-localization. Then, the excitation light beam A is moved over the sample by means of the lateral beam deflection device 15 and optionally also by means of the axial beam deflection device 17 to target the scanning positions 201 with the local minimum 110 of the excitation light distribution 100. Meanwhile, the deactivation light distribution 300 particularly remains stationary.

FIG. 5 shows a schematic cross-sectional view of a second beam shaping device 16b for phase modulating the deactivation light beam D. The second beam shaping device has an active surface 160 with a blazed grating, which diffracts the incident deactivation light beam D in a desired order and thus couples it into the further beam path so that the deactivation light beam is focused by the objective 19 into the sample 20. A phase pattern can further be superimposed on the active surface with the blazed grating, so that a corresponding phase distribution is imposed on the deactivation light beam D, which forms the deactivation light distribution 300 at the focus by interference. In particular, the active surface 160 is a plane conjugate to the pupil 19a of the objective 19 (see FIGS. 3-4). The phase pattern can be generated, in particular, in the form of controllable pixels, wherein a phase value can be specified for each pixel. The phase pattern and in particular also the orientation of the blazed grating are controllable by means of the control unit 24.

FIG. 5 further schematically illustrates an outer region 161 of the active surface 160 and an inner region 162 of the active surface 160 enclosed by the outer region 161.

By means of the control unit 24, the orientation of the blazed grating can be changed in the outer region 161 such that the deactivation light beam D is not coupled into the beam path but, for example, into a beam trap (not shown). In this way, the beam cross-section of the deactivation light beam D can be reduced such that the pupil 19a of the lens 19 is under-illuminated and thus the deactivation light distribution 300 is stretched in the direction of the optical axis OA (i.e., axially).

In another embodiment, the inner region 162 may represent the first phase pattern for generating the deactivation light distribution 300 and the outer region 161 may represent a second phase pattern that effectively results in reducing the beam cross-section of the deactivation light beam D and thus axially stretching the deactivation light distribution 300.

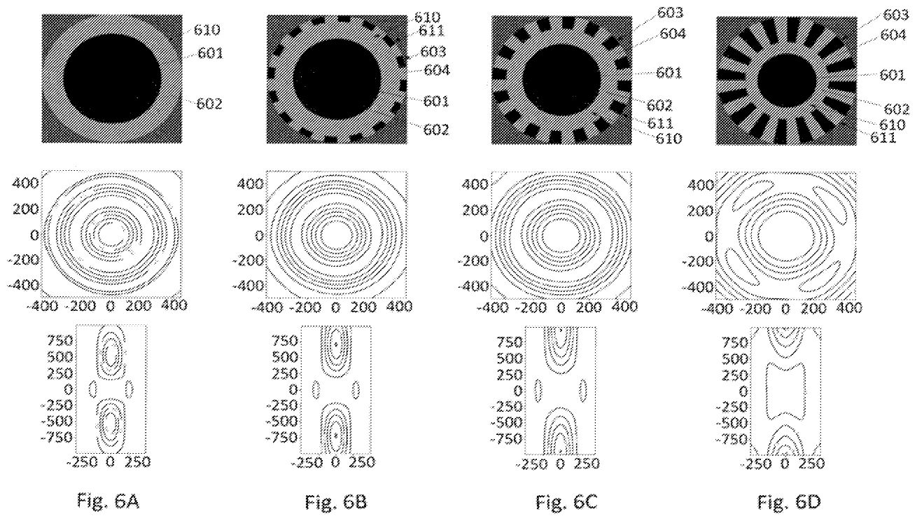

FIGS. 6 to 7 and 9 to 10 show phase patterns (FIGS. 6A-D, above) that can be generated, for example, on an active surface 160 of a beam shaping device 16a,16b to modulate the phase distribution of the excitation light beam A or the deactivation light beam D, in particular the deactivation light beam D, so that a corresponding light intensity distribution with a local minimum is produced at the focus of the respective light beam in the sample 20 by interference. Below the phase patterns, contour plots of corresponding simulated light distributions are shown, respectively as a section through the focal plane (x-y plane, perpendicular to the optical axis, where the z coordinate is zero, FIG. 6A-D, center) and as a section in the y-z plane, where the x coordinate is zero (FIG. 6A-D, bottom). The location coordinates in FIGS. 6A-D, center and bottom, are each in units of micrometers. In particular, the phase patterns are generated in a plane conjugate to the plane of the pupil 19a of the objective 19.

FIG. 6A (top) shows a first phase pattern 610 consisting of a first ring 602 arranged concentrically around a circular disk 601, wherein the first ring 602 and the circular disk 601 have a phase difference of π with respect to each other. With such a phase pattern, a 3D donut (also referred to as a bottle beam) with a central local minimum 310 can be generated at the focus of the phase-modulated light beam.

Also shown in each of FIGS. 6B to 6D (top) is a first phase pattern 610 having a first ring 602 arranged concentrically around a circular disk 601, wherein the circular disk 601 and the first ring 602 have a phase shift of π. However, the radius of the first ring 602 and the circular disk 601 are each smaller than in the first phase pattern 610 shown in FIG. 6A (above). In addition, FIGS. 6B-6D show another second phase pattern 611 comprising a second ring 603 concentrically arranged around the first ring 602 of the first phase pattern 610. This second ring 603 comprises a plurality of segments 604 having alternating phase values corresponding to the phase value of the first ring 602 and the phase value of the circular disk 601. Accordingly, the segments 604 adjacent on the second ring 603 comprise phase jumps of π with respect to each other. In the example shown here, all segments 604 have identical dimensions and are thus symmetrically arranged around the first ring 602.

As can be seen from the comparison between the contour line diagrams in FIG. 6A (bottom) and FIG. 6B (bottom), the additional second phase pattern 611 with the segmented second ring 603 results in a stretching of the 3D donut in the axial direction (z-direction). In contrast, there is only a slight change in the light intensity distribution in the focal plane (FIGS. 6A and 6B, center). Stretching a 3D donut-shaped deactivation light distribution 300 in the z-direction is advantageous for the method according to the invention, since it can effectively suppress background emission from regions lying above and below the focus in the z-direction.

Furthermore, it can be seen from FIGS. 6C and 6D that by widening the second ring 603 radially inward while simultaneously reducing the size of the circular disk 601, an even further stretching in the z-direction can be achieved than for the case shown in FIG. 6A. In the configuration shown in FIG. 6D, a broadening of the central local minimum 310 in the focal plane is additionally visible (FIG. 6D, center), which can also have a beneficial effect on the suppression of background fluorescence.

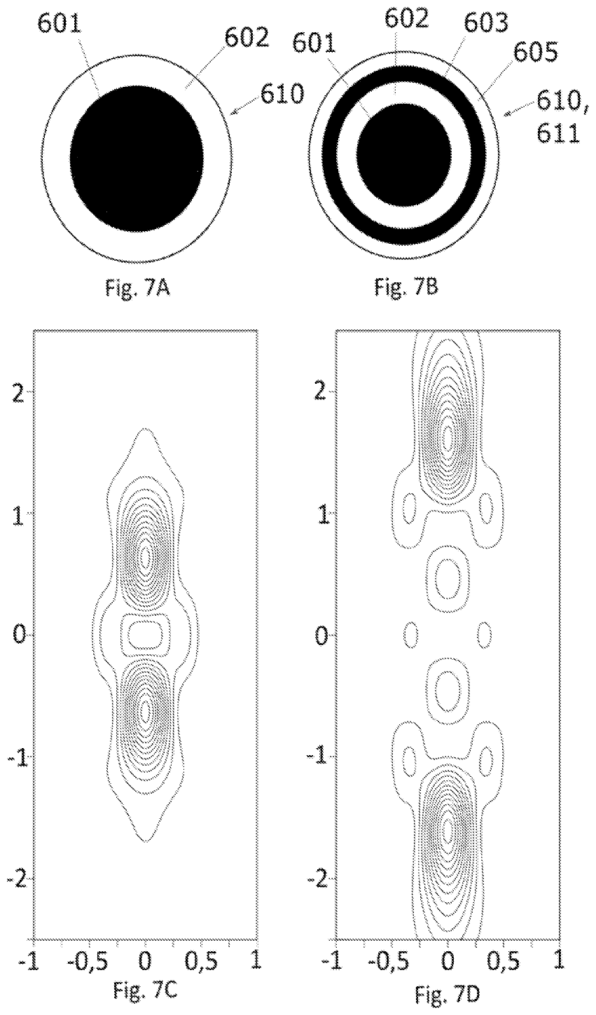

FIGS. 7A and 7B show additional phase patterns for phase modulation of the deactivation light beam. FIGS. 7C-D show corresponding contour plots of the light intensity distribution in the XZ plane obtained at the focus, with FIG. 7C corresponding to the phase pattern shown in FIG. 7A and FIG. 7D corresponding to the phase pattern shown in FIG. 7B. FIG. 7A, like FIG. 6A, shows a first phase pattern formed by a circular disk 601 and a first ring 602 concentrically arranged around the circular disk 601, with a phase difference of π. Accordingly, FIG. 7C shows the contour line diagram of a 3D donut.

According to FIG. 7B, in addition to the circular disk 601 and the first ring 602, a second ring 603 and a third ring 605 are provided, with adjacent rings each having a phase difference of π from one another. This advantageously results in an intensity distribution stretched in the z-direction at the focus (FIG. 7D). The scales are given in the unit μm.

FIGS. 8A-D show plots along a direction in the focal plane (e.g., along the x-coordinate) of a simulated 2D donut-shaped excitation light distribution 100 with a wavelength of 642 nm each superimposed on simulated 2D donut-shaped deactivation light distributions 300 of different shapes and widths with a wavelength of 775 nm. The scale of the x-axis is in units of micrometers. The excitation light distribution 100 has a central local minimum 110 and the deactivation light distributions 300 each have at least one local minimum 310. Adjacent to the local minima 110, 310, the distributions 100, 300 have intensity increasing areas 120, 320 and at least two local maxima 130, 330 each. The excitation light distribution 100 was generated by phase modulating the excitation light beam A with a vortex-shaped phase pattern in a plane conjugate to the objective pupil, which has phase values gradually increasing from 0 to 2π in a clockwise circumferential direction with respect to the optical axis. In addition, the excitation light beam A has been left circularly polarized so that the excitation light distribution 100 is obtained in the focal plane by interference.

The deactivation light distribution 300 shown in FIG. 8A was generated by phase modulating the deactivation light beam 100 with the same vortex-shaped phase pattern, also with left circular polarization. The local minima 110, 310 of the distributions 100, 300 are here at the same position. The deactivation light distribution 300 according to FIG. 8A is slightly wider than the excitation light distribution 100 due to the higher wavelength.

In contrast, the deactivation light distributions 300 shown in FIGS. 8B to 8D were generated with vortex-shaped phase patterns that have gradually increasing first phase patterns in the circumferential direction between 0 and 4π (FIG. 8B), 0 and 6π (FIG. 8C), and 0 and 10p (FIG. 8D), respectively. As a result, as the maximum phase value increases, the deactivation light distributions 300 exhibit an increasing width, i.e., a greater distance between the local maxima 130, 330 adjacent to the local minimum 110, 310 and a wider region of relatively low light intensity between the local maxima 130, 330. This region is particularly wide for a maximum of 10π. Advantageously, the deactivation light of these distributions reduces the background fluorescence but does not significantly affect the detection PSF of the emission light.

The deactivation light distribution 300 shown in FIG. 8B comprises a further local maximum 330 at the position of the minimum of the excitation light distribution 100. This effect results from the polarization direction of the light in this particular phase pattern (vortex pattern from 0 to 4π).

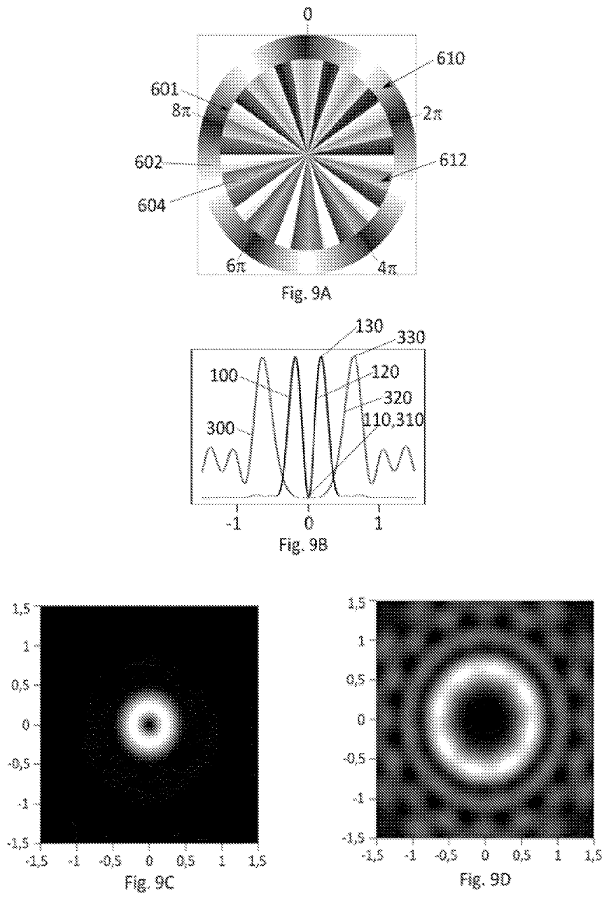

FIG. 9A shows a first phase pattern 610 for generating the deactivation light distribution 300 shown in FIGS. 9B and 9D, which is overlaid with a third phase pattern 612 for generating secondary maxima. The first phase pattern 610 is vortex-shaped with phase increasing in the circumferential direction from 0 to 10π. This pattern is superimposed with a third phase pattern 612 in the form of a circular disk 601 divided into segments 604, the segments 604 having a phase difference relative to the radially adjacent region of the first ring 602 of

$$+ \frac{π}{2} or - \frac{π}{2} .$$

The outer region of the superimposed phase pattern, on which the multiple vortex phase pattern is best seen, forms a first ring 602 concentrically arranged around the circular disk 601. The segments 604 with positive and negative phase jump to the first ring 602 are thereby arranged alternately. Accordingly, segments 604 adjacent to each other in the circumferential direction each have a phase difference of π.

The phase pattern shown can be used to create a 2D donut-shaped deactivation light distribution 300 with a wide range of low intensity around the central local minimum 310 (see FIG. 8D) and additional secondary maxima of light intensity. These secondary maxima advantageously suppress background emission in areas further away from the focus.

FIG. 9B shows a plot of the deactivation light distribution 300 along the x coordinate. FIG. 9D shows a 2D plot of the deactivation light distribution 300 in the xy plane, and FIG. 9C shows an xy plot of a 2D donut of the deactivation light distribution 300 shown in FIG. 8A for comparison.

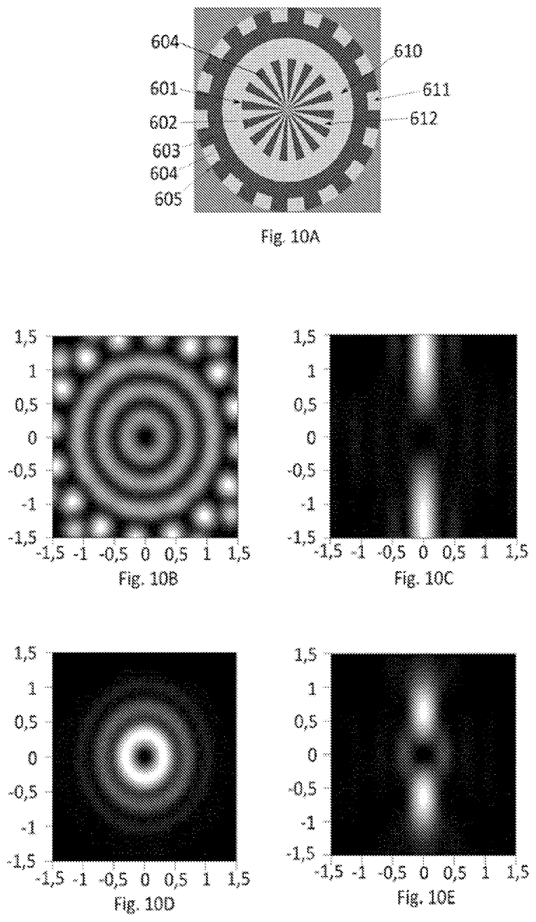

FIG. 10A shows another first phase pattern 610 for phase modulating the deactivation light, which is superimposed with a second phase pattern 611 for stretching the deactivation light distribution 300 in the z-direction and with a third phase pattern 612 for generating secondary maxima. The first phase pattern 610 comprises a first ring 602 and a second ring 603 arranged concentrically around the first ring 602, the first ring 602 and the second ring 603 having a phase difference of π with respect to each other so that a 3D donut is formed at the focus. The second phase pattern 611 is formed by a third ring 605 arranged concentrically around the second ring 603, the third ring 605 being divided into alternating segments 604, the segments 604 having alternating phase differences of 0 or π relative to the second ring 603. The third phase pattern 612 forms a circular disk 601 arranged concentrically within the first ring 602, which is divided into segments 604 having alternating phase differences of 0 or π relative to the first ring 602.

FIGS. 10B and 10C show a corresponding deactivation light distribution 300 in the focus generated by the phase pattern shown in FIG. 10A, wherein FIG. 10B is an x-y section (focal plane) and FIG. 10C is an x-z section. FIGS. 10D and 10E show sections through a regular 3D donut, i.e., bottle beam (see phase patterns FIGS. 6A and 7A) for comparison. All scales have the unit μm.

In particular, as can be seen from FIG. 10B, the third phase pattern 612 creates secondary maxima that have a beneficial effect on the suppression of background emission by the deactivation light. Additionally, the deactivation light distribution 300 is stretched in the z-direction by the second phase pattern 611, as can be seen from FIG. 10C.

### LIST OF REFERENCE SIGNS

1 Device for determining positions of a molecule

2 Optical arrangement

11 Excitation light source

12 deactivation light source

13a First beam splitter

13b Second beam splitter

13c Third beam splitter

13d Fourth beam splitter

14a First mirror

14b Second mirror

14c Third mirror

14d Fourth mirror

15 Lateral beam deflection device

15a First beam deflection unit

15b Second beam deflection unit

16a First beam shaping device

16b Second beam shaping device

17 Axial beam deflection device

18 Scanning device

19 Objective

19a Pupil

20 Sample

21 Pinhole

22 Detector

23 Computing unit

24 Control unit

100 Excitation light distribution

101 Generating a plurality of light distributions

102 Illuminating with the excitation light distribution

103 Detecting emitted photons

104 Deriving the position of the molecule

110 Local minimum of the excitation light distribution

120 Intensity increasing region of the excitation light distribution

130 Local maximum of the excitation light distribution

160 Active surface

161 Outer region

162 Inner region

200 Scanning region

201 Scanning position

210 Catch region

300 Deactivation light distribution

310 Local minimum of the deactivation light distribution

320 Intensity increasing region of the deactivation light distribution

330 Local maximum of the deactivation light distribution

601 Circular disk

602 First ring

603 Second ring

604 Segment

605 Third ring

610 First phase pattern

611 Second phase pattern

612 Third phase pattern

A Excitation light beam

D Deactivation light beam

E Emitted light

L Radius

M Molecule

OA Optical axis

1.-15. (canceled)

16. A method for determining positions of molecules spaced apart from one another in one or more spatial directions in a sample comprising the steps of:
generating a plurality of light distributions, each light distribution comprising a local intensity minimum and intensity increasing regions adjacent thereto, the light distributions comprising an excitation light distribution and a deactivation light distribution, particularly a STED light distribution,
illuminating the sample with the excitation light distribution and the deactivation light distribution,
detecting photons emitted by the molecule for different positionings of the excitation light distribution, and
deriving the position of the molecule based on the photons detected for the different positionings of the excitation light distribution,
wherein the local minimum of the excitation light distribution is successively arranged at a plurality of scanning positions within a scanning region, wherein the light intensity of the deactivation light in a catch region assigned to the scanning region, in which the position of the molecule can be unambiguously derived from the scanning positions and the associated detected photons, corresponds at most to three times a saturation intensity.

17. The method according to claim 16, wherein the light intensity of the deactivation light in the catch region corresponds, at most to twice the saturation intensity.

18. The method according to claim 16, wherein the light intensity of the deactivation light in the catch region corresponds at most the saturation intensity.

19. The method according to claim 16, wherein the excitation light distribution is repositioned while the deactivation light distribution is left stationary so that the local minimum of the excitation light distribution is positioned differently more than once within a vicinity of the local intensity minimum of the deactivation light distribution.

20. The method according to claim 16, wherein the excitation light distribution and the deactivation light distribution are repositioned together.

21. The method according to claim 16, wherein a region between two local maxima of the deactivation light distribution adjacent to the local intensity minimum of the deactivation light distribution is extended further, particularly at least 10% further, at least in one spatial direction than a corresponding region between two local maxima of the excitation light distribution adjacent to the local minimum of the excitation light distribution.

22. The method according to claim 16, wherein a plurality of scanning steps is performed, wherein the local minimum of the excitation light distribution in each of the scanning steps is positioned at a plurality of the scanning positions of a respective scanning region, wherein the respective scanning region of each scanning step comprises a smaller area or volume than the scanning regions of the preceding scanning steps, and the deactivation light distribution is adjusted in at least a part of the scanning steps depending on the area or volume of the respective scanning area, wherein a total intensity and/or a shape of the deactivation light distribution is adjusted depending on the area or volume of the respective scanning area.

23. The method according to claim 16, wherein the deactivation light distribution remains constant during repositioning of the excitation light distribution.

24. The method according claim 16, wherein the deactivation light distribution is formed as a 2D donut or a 3D donut.

25. The method according to claim 24, wherein the 2D donut is generated by phase modulation of the deactivation light with a first phase pattern, the first phase pattern comprising a phase increasing in a circumferential direction with respect to an optical axis, particularly continuously, from 0 to 2π·n, wherein n is a natural number greater than 1.

26. The method according to claim 16, wherein the deactivation light distribution is formed by irradiating a deactivation light beam onto the sample along an optical axis, wherein the deactivation light beam is focused into the sample by means of an objective, and wherein a beam cross-section of the deactivation light beam is adjusted such that a pupil of the objective lens is under-illuminated so that the deactivation light distribution is stretched in the direction of the optical axis.

27. The method according to claim 26, wherein the beam cross-section of the deactivation light beam is adjusted by adapting an active surface of a beam shaping device, particularly a light modulator.

28. A method according to claim 27, wherein an orientation of a blazed grating in an outer region of the active surface of the beam shaping device is adjusted

29. The method according to claim 27, wherein a second phase pattern is generated on the active surface of the beam shaping device.

30. The method according to claim 29, wherein the second phase pattern is formed as a ring extending in a circumferential direction to the optical axis.

31. The method according to claim 30, wherein the ring comprises a plurality of segments, wherein adjacent segments respectively comprise a phase difference of π to each other.

32. The method according to claim 26, wherein the deactivation light beam is formed at least approximately as a Bessel beam, particularly by means of an axicon or a light modulator.

33. A device, particularly a microscope, for determining positions of molecules spaced apart from one another in one or more spatial directions in a sample comprising
a. at least one light source for generating an excitation light beam and a deactivation light beam, particularly a STED beam,
b. at least one beam shaping device for forming an excitation light distribution from the excitation light beam and a deactivation light distribution from the deactivation light beam, wherein the excitation light distribution and the deactivation light distribution each comprise a local intensity minimum and intensity increasing regions adjacent thereto,
c. an optical arrangement for illuminating the sample with the excitation light distribution and the deactivation light distribution,
d. at least one detector for detecting photons emitted by the molecule for different positionings of the excitation light distribution, and
e. a computing unit for deriving the position of the molecule based on the photons detected for the different positionings of the excitation light distribution,
wherein the device comprises at least one beam deflection device configured to successively arrange the local minimum of the excitation light distribution at a plurality of scanning positions within a scanning region, wherein the device comprises a control unit configured to adjust the light intensity of the deactivation light in a catch region assigned to the scanning region, in which the position of the molecule can be unambiguously derived from the scanning positions and the associated detected photons, to at most three times a saturation intensity.

34. The device according to claim 33, wherein the at least one beam deflection device is configured to reposition the excitation light distribution relative to the deactivation light distribution and to position the local minimum of the excitation light distribution differently more than once within a vicinity of the local intensity minimum of the deactivation light distribution.

35. The device according to claim 33, wherein the device comprises a first beam shaping device for generating the excitation light distribution and a second beam shaping device for generating the deactivation light distribution independently of the generation of the excitation light distribution.
